(19) United States
(12) Patent Application Publication
(10) Pub. No.: US 2010/0307041 A1
(43) Pub. Date: Dec. 9, 2010

(54) Light Emitting Diode LED Internally Illuminated Sign

(76) Inventors: Peter Tian, Plano, TX (US); Yaoming Wang, Wuxi (CN)

Correspondence Address: WILSON DANIEL SWAYZE, JR., 3804 CLEARWATER CT., PLANO, TX, 75025, US

(21) Appl. No.: 12/477,738

(22) Filed: Jun. 3, 2009

(51) Int. Cl. G09F 13/02

(52) U.S. Cl. 40/575

(57) ABSTRACT

An LED sign may include a top frame member, two side frame members connected to the top frame member, a bottom frame member connected to the side frame members. A first detachable outer sheet member may include indicia to cooperate with the top frame member, the bottom frame member and the side frame members. The LED sign may further include a second translucent sheet member to cooperate with the top frame member, the bottom frame member and the side frame members. The LED sign may further include a sign frame member. The LED sign may include LED lighting modules an LED photocell. The LED lighting modules may be detachably connected to the LED sign, and the top, bottom and side frame members may be substantially U-shaped to define a channel for the outer sheet member.

### FIELD OF THE INVENTION

The present invention relates generally to an improved street sign in which, more particularly, LEDs are the source of illumination of the sign.

### BACKGROUND

Advantageous use of light emitting diodes (LEDs) for sign illumination, a building “exit” sign being an example, is already known from U.S. Pat. No. 6,026,602 for “Apparatus and Method of Indirectly Illuminating A Sign” issued to Grondal et al. on Feb. 2, 2000. In the '602 patented sign, the LEDs are positioned about the periphery of the letters spelling out the sign name to provide it with high visibility, but such a sign as known from common experience is positioned indoor to achieve egress outside for those instructed by the sign. In an outdoor sign, the LEDs are thought to be a drawback because exposure to weather elements would cause short circuits and other malfunctioning, and thus the high performance visibility afforded by LEDs is not used in a common, ordinary street sign which is relied on to provide traffic and like vital information to the public.

U.S. Pat. No. 6,705,033 discloses a street sign sealed against weather elements during outdoor use, consisting of an assemblage of panels and peripheral LEDs, optically arranged to illuminate by impingement said letters of said notched width portion rendered visible through said unnotched width portion which serves as a weather seal for said illuminated display.

However, a problem with the prior art devices is that the indicia found on the sign cannot be changed easily, and consequently, changing the indicia requires a great expense.

### SUMMARY

An LED sign may include a top frame member, two side frame members connected to the top frame member, a bottom frame member connected to the side frame members, and a first detachable outer sheet member which may include indicia to fit into the top frame member, the bottom frame member and the side frame members.

The LED sign may further include a second adjacent sheet member to fit into the top frame member, the bottom frame member and the side frame members.

The LED sign may include LED Lighting modules that may be detachably connected to the LED sign. The side frame member may be substantially U-shaped to define a channel for the outer sheet member. The top frame member may be substantially U-shaped to define a channel for the outer sheet member, and the bottom frame member may be substantially U-shaped to define a channel for the outer sheet member.

### BRIEF DESCRIPTION OF THE DRAWINGS

The invention may be understood by reference to the following description taken in conjunction with the accompanying drawings, in which like reference numerals identify like elements and in which:

FIG. 1 illustrates a perspective view of the LED sign of the present invention;

FIG. 2 illustrates an exploded view of the LED sign of the present invention;

FIG. 3 illustrates a perspective view of the LED lighting modules of the present invention;

FIG. 4 illustrates a side view of the LED lighting modules of the present invention;

FIG. 5 illustrates a bottom view or top view of the LED lighting modules of the present invention;

FIG. 6 illustrates an end view of the LED lighting modules of the present invention;

FIG. 7 illustrates a sectional view of the LED lighting modules of the present invention;

FIG. 8 illustrates a cross-sectional view of the LED sign of the present invention;

FIG. 9 illustrates an exploded view of the LED lighting modules of the present invention;

FIG. 10 illustrates the outer sheet member being replaced.

### DETAILED DESCRIPTION

The present invention relates to an LED sign 100 which may include LED modules which may be mounted inside along the top and bottom edges of the LED sign 100 or other locations within the LED sign 100 and may be used for street name signs, commercial signs, information announcements or notices in public and private settings or anywhere else a sign may be used. The LED modules may be used as a light source for the LED sign 100 and may be of uniform size for ease of replacement. In order to accommodate different sizes for the LED sign 100, a number of LED modules may be employed as a light source. For example, if the LED sign 100 is 6 feet long, (3) 2-foot long LED strip modules could be employed. By mounting the strip modules along the top and bottom edges of the LED sign 100, the light from the LED diodes may be deflected inside the LED sign 100 from one side of the box to the other, back-and-forth. In this way, the light sources are efficiently utilized in order to achieve a bright and even illumination. The LED sign 100 may be a single-sided sign box or a double-sided sign box. With a single-sided sign box, a layer of reflective sheeting may allow nearly 100% use of the diode light to be reflected to the front side of the sign box. This increases the brightness of the sign box significantly as a result of the reflective sheeting layer. The LED strip module may be an all-inclusive module including LED diodes, board and heat dispensing structure. If the LED module should be defective, the module can be easily and quickly replaced. This eliminates the need for the entire LED sign 100 to be replaced. The present invention may include a clear polycarbonate sheet which may be mounted on the front surface of the LED sign 100. The indicia for the sign may be made by cutting either a diamond grade or engineering grade reflective film or other appropriate films which may be attached or glued on the surface of the polycarbonate sheet. The bottom frame member may be removed to allow the polycarbonate sheet to be replaced, eliminating the need for the entire LED sign 100 to be replaced. A different polycarbonate sheet can be inserted, and the bottom frame member can be reattached with new indicia.

The LED sign 100 may be used in commercial areas or industries and even may have private use. The LED sign 100 may be used for street name signs, guiding or warning messages on freeways or local roads, outdoor commercial advertising, instruction signs in public places, signage for airports etc. Its many advantages include: low energy/electric cost, long service time without maintenance or replacement, high aesthetic appearance, even brightness, light weight, easy installation, reusability by allowing the message to be changed, and easy sign repair and maintenance work due to replaceable components. A power supply may be integrated inside of the LED sign 100 in order to provide water/moisture-proof operation. A photocell may be placed on the side of the LED box 100 for automatically turning the LED lights on and off during daytime and nighttime, respectively. The frame of the LED sign 100 may be formed from a lightweight metal material, such as aluminum, to facilitate easy installation and maintenance. Other heavy-duty materials, such as steel, could also be employed. The exterior frame of the LED sign 100 may include four detachable U-shaped channel caps, namely the top and bottom frame members and the two ends. The channel caps may be held in place by screw type self lock fasteners. The frame can be assembled or disassembled by using screws to attach and detach the top and bottom U-shaped channel edge covers.

FIG. 1 illustrates a perspective view of the LED sign 100 of the present invention which may be formed from frame members which may be substantially thin, rigid, flat and U-shaped members which may be made from metals such as steel or other appropriate material.

FIG. 1 illustrates a side frame member 101, which may be substantially U-shaped and which is connected to an opposing side frame member 101 by a top frame member 103 which may be substantially U-shaped, and opposing bottom frame member 105 which may be substantially U-shaped. FIG. 1 additionally illustrates that an outer sheet member 109 may be positioned in a continuous channel 113 formed by the side members 101, the top frame member 103, and the bottom frame member 105.

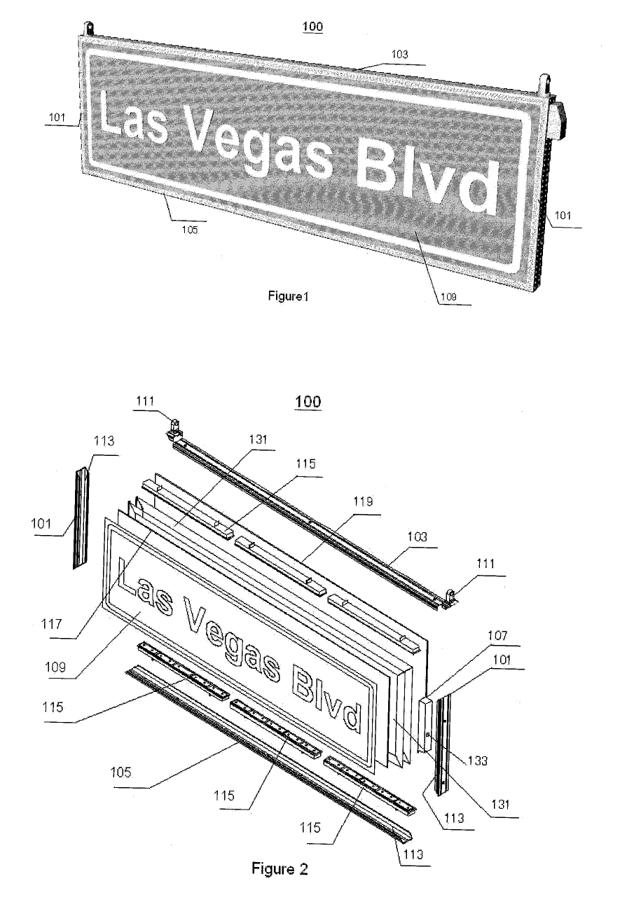

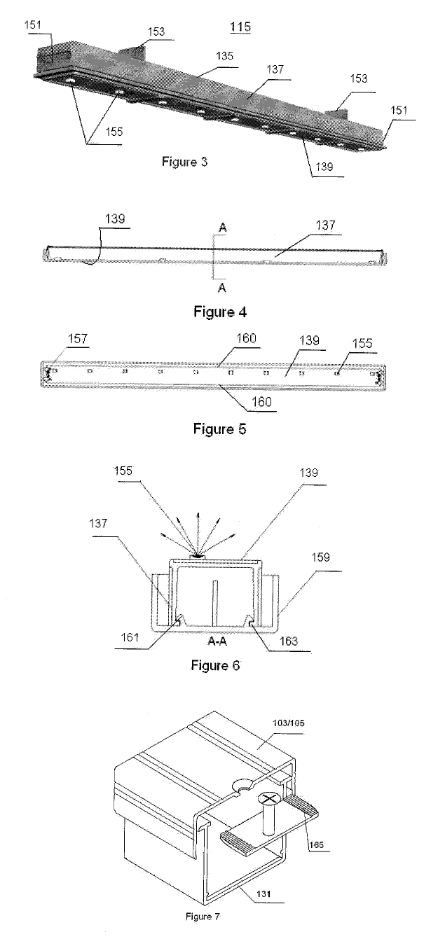

FIG. 2 illustrates a side frame member 101 which may be substantially U-shaped which is connected to an opposing side frame member 101 by a top frame member 103 which may be substantially U-shaped and opposing bottom frame member 105 which may be substantially U-shaped. FIG. 2 additionally illustrates that outer sheet member 109 may be positioned in a continuous channel 113 formed by the side members 101, the top frame member 103 and the bottom frame member 105. FIG. 2 illustrates internal structure frame member 131 which the side frame members 101, the top frame member 103, and the bottom frame member 105 are detachably mounted on by a fastening device 165.

FIG. 2 additionally illustrates LED Lighting modules 115 which may include LEDs, or lights, and which is shown as an elongated device which may extend across the bottom of the LED sign 100. FIG. 2 shows plurality of the LED lighting modules 115, and alternatively, an individual LED lighting module could be employed.

FIG. 2 additionally illustrates an inner light distributing sheet member 117 which may co-exist with the outer sheet member 109 and may be formed from plastic or other suitable material in order to uniformly distribute the light generated from the LED lighting modules 115. The inner light distributing sheet member 117 may be positioned within the channel 113.

FIG. 2 additionally illustrates a sign rear panel member 119 which may be a rectangle with a relatively narrow edge which extends around the periphery of the sign rear panel member 119. Reflective material attached to the inner surface allows the light to interact with the inner light distributing sheet member 117 and may be generally coextensive with the outer sheet member 109.

FIG. 2 illustrates the power supply member 107 which may include a photocell 133 to detect relative darkness and to operate the sign 100 in response to the relative darkness.

FIG. 2 additionally illustrates that the LED light modules 115 may extend longitudinally from side to side across the top or bottom of the sign 100.

FIG. 3 illustrates the LED lighting modules 115 which may include a top surface 135, a pair of opposing side surfaces 137, a bottom surface 139 and a pair of opposing end surfaces 151 to form a substantially rectangular form. FIG. 3 additionally illustrates a handle member 153 to insert or remove the LED module. FIG. 3 additionally illustrates LEDs 155 which are positioned within the bottom surface 139 of the LED Lighting modules 115.

FIG. 4 illustrates a side view of the LED Lighting modules 115 and illustrates a side surface 137.

FIG. 5 illustrates a bottom view of the LED Lighting modules 115, the bottom surface 139 of the LED Lighting modules 115, the LED lights 155. FIG. 5 additionally illustrates electrical connectors 157 which are connected to wires 160 that power the LED lights 155.

FIG. 6 illustrates an alternate design which may include a top cover member 159, which may be U-shaped, and may include fastening arms 161 which engage a shoulder 163 of the side surface 137.

FIG. 7 illustrates that the top frame member 103 or the bottom frame member 105 may be detachably connected to the internal structure frame member 131 by the fastening device 165. By removing the top frame member 103 or the bottom frame member 105, the outer sheet member 109 may be changed/replaced. Consequently, since the outer sheet member 109 may include indicia to indicate the sign message, such as a street name or location, the indicia can be quickly and easily changed. Furthermore, the LED lighting modules 115 can be replaced if defective.

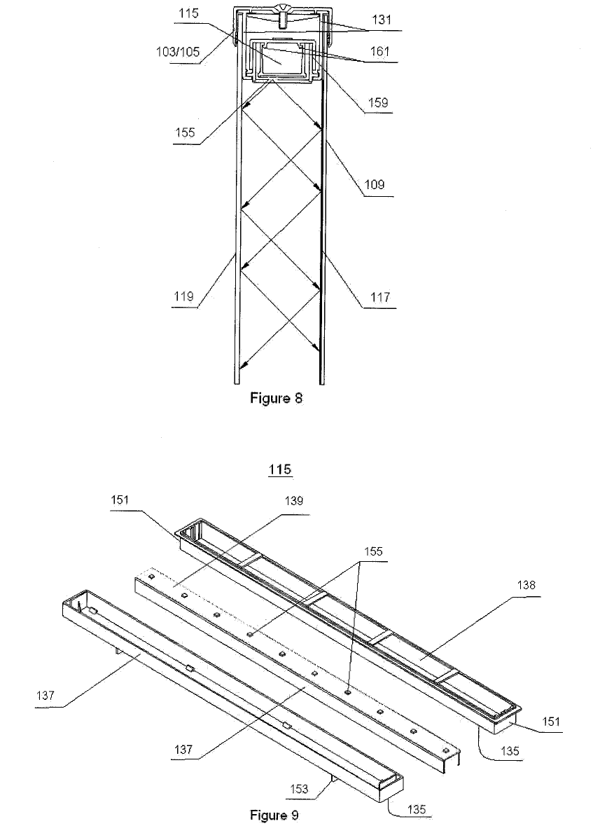

FIG. 8 illustrates a cross-sectional view of the LED sign 100 of the present invention. FIG. 8 illustrates the top frame member 103 (or may illustrate alternatively the bottom frame member 105) which may mechanically engage with the internal structure frame member 131. Furthermore, the top frame member 103 (the bottom frame member 105) may cooperate with the rear panel member 119, the outer sheet member 109, and the inner light distributing sheet member 117. FIG. 8 illustrates that LED lighting modules 115 are positioned within the structure frame 131, which is between the top frame member 103 (the bottom frame member 105), the inner light distributing sheet member 117, and the rear panel member 119.

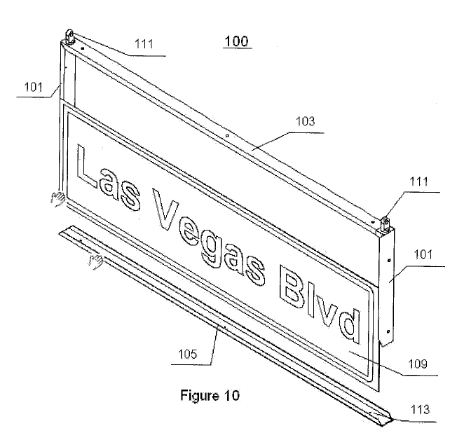

FIG. 9 illustrates an exploded view of the LED lighting modules 115. FIG. 9 illustrates the LED lighting modules 115, which may include the top surface 135, the side surface 137, the LED lights 155, the handle members 153, the end surface 151, and the bottom surface 139 which may include apertures 138.

FIG. 10 illustrates the LED sign 100 and illustrates that the bottom frame member 105 has been removed from the LED sign 100 and the outer sheet member 109 is being replaced. FIG. 10 additionally illustrates the hanger 111, the top frame member 103 and the side frame member 101.

While the invention is adaptable to various modifications and alternative forms, specific embodiments thereof have been shown by way of example in the drawings and are herein described in detail. It should be understood, however, that the description herein of specific embodiments is not intended to limit the invention to the particular forms disclosed.

1) An LED sign, comprising:
a top frame member;
a side frame member connected to the top frame member;
a bottom frame member connected to the side frame members;
an internal structure frame member connected to the top, the side, and the bottom frame members;
a first detachable outer sheet member including indicia to cooperate with the top frame member, the bottom frame member and the side frame members.

2) An LED sign as in claim 1, wherein the LED sign further includes a second translucent sheet member, adjacent to the first detachable outer sheet, that engages with the top frame member, the bottom frame member and the side frame members.

3) An LED sign as in claim 1, wherein the LED sign further includes a rear panel with reflective material attached to the inner surface to reflect the light produced by the LED lighting modules.

4) An LED sign as in claim 1, wherein the LED sign includes a power supply member to supply power from an external source.

5) An LED sign as in claim 1, wherein the LED sign includes a removable LED lighting module.

6) An LED sign as in claim 6, wherein the LED sign includes an LED photocell.

7) An LED sign as in claim 5, wherein the LED lighting modules are detachably connected to the LED sign.

9) An LED sign as in claim 1, wherein the side frame members are substantially U-shaped to define a channel for the outer sheet member.

10) An LED sign as in claim 1, wherein the top frame member is substantially U-shaped to define a channel for the outer sheet member.

11) An LED sign as in claim 1, wherein the bottom frame member is substantially U-shaped to define a channel for the outer sheet member.
